(19) United States
(12) Patent Application Publication
(10) Pub. No.: US 2012/0196024 A1
(43) Pub. Date: Aug. 2, 2012

(54) REMOVING COMPOUNDS FROM WINE

(75) Inventor: Mark Allen Kelm, Fresno, CA (US)

(73) Assignee: CONSTELLATION WINES U.S., INC., Canandaigua, NY (US)

(21) Appl. No.: 13/361,893

(22) Filed: Jan. 30, 2012

Related U.S. Application Data
(60) Provisional application No. 61/438,614, filed on Feb. 1, 2011.
(60) Provisional application No. 61/565,967, filed on Dec. 1, 2011.

(51) Int. Cl. C12H 1/056; A23L 2/80

(52) U.S. Cl. 426/592; 426/599

(57) ABSTRACT

Methods for improving organoleptic characteristics of wine and/or juice using molecularly imprinted polymers are described.

### CROSS-REFERENCE TO RELATED APPLICATIONS

This application claims the benefit of U.S. Provisional Patent Application Ser. Nos. 61/438,614, filed Feb. 1, 2011 and 61/565,967, filed Dec. 1, 2011, which are incorporated herein by reference.

### FIELD OF THE INVENTION

The invention relates to improving organoleptic characteristics of wine and/or juice using molecularly imprinted polymers.

### BACKGROUND OF THE INVENTION

The varied types and abundance of aroma compounds in grapes contribute to a wine's quality and varietal distinction. Accordingly, these chemistries have significant economic implications for commercial wine production, especially if the aromas present are considered undesirable. One particular aroma/flavor defect that frequently occurs in Bordelaise varietal grapes grown in cooler climates is that of “vegetativeness” often described as “green”, “unripe”, “herbaceous” or “bell pepper” like. Said grapes typically produce more of the methoxypyrazine compounds, which characteristically exhibit herbaceous, green bell pepper-like aromas, and when present in sufficient quantities can negatively characterize a wine. Thus, there is a need for methods that can correct these aroma and flavor defects, by removal of undesirable constituents such as methoxypyrazines, from juice and/or wine.

Molecularly imprinted polymers (MIPs) are polymers that have been prepared in the presence of a target molecule that is subsequently removed, thereby leaving a cavity in the MIP that corresponds to the target molecule. When the MIPs are added to a sample containing the target molecule, the MIP specifically binds to the target molecule. The MIP-target molecule complex can then be removed from the sample. For example, US 2002/0012727 reports that MIPs are useful in decaffeinating coffee or tea.

Garde-Cerdan et al., “Molecularly Imprinted Polymer-Assisted Simple Clean-Up of 2,4,6-Trichoroanisole and Ethylphenols from Aged Red Wines”, Am. J. Enol. Vitic. 59:4 (2008) describes mixed results in removing various compounds from aged red wines. In some instances, the authors found no significant difference between the use of MIPs and nonimprinted polymers in extracting certain compounds.

### DETAILED DESCRIPTION OF THE INVENTION

Compounds such as those causing aroma defects are removed from wine by combining methoxypyrazine-containing wine with a methoxypyrazine-specific MIP, thereby forming a MIP-methoxypyrazine complex. The MIP-methoxypyrazine complex is then removed from the wine.

Methoxypyrazine-specific MIPs specific for target compounds can be prepared by methods known in the art. See, e.g., U.S. Pat. No. 6,127,154, which is incorporated herein by reference. See also Lin et al., “Molecularly Imprinted Polymeric Beads for Decaffeination”, J. Med. Biol. Eng., 23(2):53-56 (2003), which is incorporated herein by reference. In a preferred embodiment, the MIPs bind a high percentage of the target compound and bind a low percentage of non-target compounds; that is, the MIPs demonstrate high selectivity, sensitivity and specificity. Herein, MIPs can be prepared using one or more methoxypyrazines as the target compound. In one embodiment, 2-isobutyl-3-methoxypyrazine is the target compound used to prepare the MIPs. Other target compounds include odorants, tastants and tactile compounds, such as 2,4,6-trichloroanisole, 2-methylisoborneol, Geosmin (4,8a-dimethyldecalin-4a-ol), Methanethiol (methylmercaptan), Ethanethiol (ethylmercaptan), Dimethyl sulfide, Diethyl disulfide, Hydrogen sulfide, Acrolein (propenal), Acetic acid, Acetaldehyde, Amyl acetate, Diacetyl, Ethyl acetate, 4-ethylphenol, 4-ethylguaiacol, Vinyl-4-phenol, Isovaleric acid, 2-ethoxyhexa-3,5-diene, 2-acetyl-3,4,5,6-tetrahydropyridine, 2-acetyl-3,4,5,6-tetrahydropyridine, 2-ethyltetrahydropyridine, 2-acetyl-1-pyrrolene, Geraniol (3,7-Dimethylocta-2,6-diene-1-ol), Linalool (3,7-Dimethylocta-1,6-diene-3-ol), halogenated aromatics, trichlorophenol, tribromoanisole, guaiacol, 4-methylguaiacol, 4,5-dichloroguaiacol, chlorovanillin, biogenic amines, histamine, tyramine, putrescine, phenylethylamine, Pronthocyanidins (a.k.a. condensed tannins), 4-aminoacetophenone, 1,1,6-trimethyl-1,2-dihydronaphthaline (TDN), 4-vinylguaiacol, cis-rose oxide, isopropylmethoxypyrazine, 2,3-butanedione, 3-hydroxybutanone, 2-mercaptoethanol, 1,1,6-trimethyl-1,2-dihydronaphthalene (TDN), C13 norisoprenoid precursors of TDN (e.g. β-damascenone, β-ionone, vitispirane, actinidols, etc.), cis-3-Hexen-1-ol, 2-Methoxy-3,5-dimethylpyrazine and 2-secButyl-3-methoxypyrazine.

Removal of the MIP-methoxypyrazine complex is preferably done by methods known in the art, such as chromatography or solid phase extraction (SPE). See, e.g., Weiss et al., “Molecular Imprinting and Solid Phase Extraction of Flavonoid Compounds”, Bioseparation, 10:379-87 (2002), which is incorporated herein by reference.

The process of the invention preferably results in the removal of at least 25%, 50%, 75%, 90%, 95% or 99% of the target compound. In one embodiment, wine with a perceptible odor level of methoxypyrazines is purified to an extent sufficient to render the methoxypyrazines imperceptible by one having ordinary skill in the art, such as an ordinary enologist.

In preferred embodiments, the selective removal of target compounds from wine or juice results in defect mitigation and/or tailoring of a wine and/or juice's overall organoleptic profile to satisfy enologist and/or consumer preferences.

What is claimed is:

1. A method for removing methoxypyrazines from wine and/or juice comprising:
combining methoxypyrazine-containing wine/juice with a methoxypyrazine-specific MIP, thereby forming a MIP-methoxypyrazine complex; and
removing the MIP-methoxypyrazine complex from the wine/juice.

2. The method of claim 1, wherein the methoxypyrazine comprises 2-isobutyl-3-methoxypyrazine.

3. The method of claim 1, wherein the methoxypyrazine consists essentially of 2-isobutyl-3-methoxypyrazine.

4. A method for removal of undesirable compounds in wine and/or juice comprising:
providing wine/juice containing a perceptible odor level of methoxypyrazine;
combining the wine/juice with a methoxypyrazine-specific MIP, thereby forming a MIP-methoxypyrazine complex; and
removing the MIP-methoxypyrazine complex from the wine/juice, wherein the result of the removing step is a wine/juice containing an imperceptible level of methoxypyrazine.

5. The method of claim 4, wherein the wine/juice provided contains 2-isobutyl-3-methoxypyrazine and wherein at least 25%, 50%, 75%, 90%, 95% or 99% of the 2-isobutyl-3-methoxypyrazine is removed.

6. A method of modifying the organoleptic profile of wine and/or juice comprising:
combining wine/juice containing a target compound with a target-compound-specific MIP, thereby forming a MIP-target complex; and
removing a sufficient amount of the MIP-target complex from the wine/juice to modify at least one organoleptic property of the wine/juice.

7. The method of claim 6, wherein the target compound is selected from an odorant, a tastant, a tactile compound, and combinations thereof.

8. A method for removing a target compound from wine and/or juice comprising:
combining target-containing wine/juice with a target-specific MIP, thereby forming a MIP-target complex; and
removing the MIP-target complex from the wine/juice.

9. The method of claim 8, wherein the target is selected from the group consisting of: 2,4,6-trichloroanisole, 2-methylisoborneol, Geosmin (4,8a-dimethyldecalin-4a-ol), Methanethiol (methylmercaptan), Ethanethiol (ethylmercaptan), Dimethyl sulfide, Diethyl disulfide, Hydrogen sulfide, Acrolein (propenal), Acetic acid, Acetaldehyde, Amyl acetate, Diacetyl, Ethyl acetate, 4-ethylphenol, 4-ethylguaiacol, Vinyl-4-phenol, Isovaleric acid, 2-ethoxyhexa-3,5-diene, 2-acetyl-3,4,5,6-tetrahydropyridine, 2-acetyl-3,4,5,6-tetrahydropyridine, 2-ethyltetrahydropyridine, 2-acetyl-1-pyrrolene, Geraniol (3,7-Dimethylocta-2,6-diene-1-ol), Linalool (3,7-Dimethylocta-1,6-diene-3-ol), halogenated aromatics, trichlorophenol, tribromoanisole, guaiacol, 4-methylguaiacol, 4,5-dichloroguaiacol, chlorovanillin, biogenic amines, histamine, tyramine, putrescine, phenylethylamine, Pronthocyanidins (a.k.a. condensed tannins), 4-aminoacetophenone, 1,1,6-trimethyl-1,2-dihydronaphthaline (TDN), 4-vinylguaiacol, cis-rose oxide, isopropylmethoxypyrazine, 2,3-butanedione, 3-hydroxybutanone, 2-mercaptoethanol, 1,1,6-trimethyl-1,2-dihydronaphthalene (TDN), C13 norisoprenoid precursors of TDN (e.g. β-damascenone, β-ionone, vitispirane, actinidols, etc.), cis-3-Hexen-1-ol, 2-Methoxy-3,5-dimethylpyrazine and 2-secButyl-3-methoxypyrazine.
